(19) United States
(12) Patent Application Publication
(10) Pub. No.: US 2019/0017587 A1
(43) Pub. Date: Jan. 17, 2019

(54) RACK-AND-PINION GEAR FOR A MOTOR VEHICLE

(71) Applicant: FORD GLOBAL TECHNOLOGIES, LLC, Dearborn, MI (US)

(72) Inventors: Kianmin DJIE, Cologne NRW (DE); Gerhard FRIEDERICH, Bornheim NRW (DE); Alexander EIN WALDT, Cologne NRW (DE)

(73) Assignee: FORD GLOBAL TECHNOLOGIES, LLC, Dearborn, MI (US)

(21) Appl. No.: 16/024,379

(22) Filed: Jun. 29, 2018

(30) Foreign Application Priority Data
Jul. 14, 2017 (DE) 10 2017 212 070.3

(51) Int. Cl. F16H 57/022; F16H 19/04; B62D 3/12; F16C 17/10

(52) U.S. Cl. CPC F16H 57/022; F16H 19/04; B62D 3/12; F16C 2361/61; F16H 2057/0225; F16H 2057/0222; F16C 17/102

(57) ABSTRACT

The disclosure concerns a rack-and-pinion gear for a motor vehicle. The rack-and-pinion gear includes a pinion shaft and a toothed rack, which are mounted inside a housing. In order to provide a rack-and-pinion gear with precise engagement, which can be produced economically, according to the disclosure it is provided that a position of the pinion shaft in the housing can be adjusted by at least one adjustment element so that a tilt of the pinion shaft relative to the toothed rack can be set.

### CROSS-REFERENCE TO RELATED APPLICATIONS

This application claims foreign priority benefits under 35 U.S.C. § 119(a)-(d) to DE Application 10 2017 212 070.3 filed Jul. 14, 2017, which is hereby incorporated by reference in its entirety.

### TECHNICAL FIELD

The disclosure concerns a rack-and-pinion gear for a motor vehicle with a pinion shaft and a toothed rack that are mounted inside a housing.

### BACKGROUND

The steering gear of motor vehicles, in particular cars, normally comprises a rack-and-pinion steering gear. Here, a pinion shaft that is rotated by a steering wheel cooperates with a toothed rack, which in turn acts on track rods. The toothed rack is pressed against a pinion of the pinion shaft via a spring pressure piece. Both the pinion shaft and the toothed rack are arranged at least partially inside a steering gear housing in which the pinion shaft and toothed rack are guided rotatably or displaceably. In order to allow optimum engagement of the pinion with the toothed rack, during production, particularly tight tolerances must be observed. This applies firstly for example to an incline angle of the pinion and the toothed rack, and secondly to production of the steering gear housing. Particular attention is directed at an angle at which the pinion shaft acts on the toothed rack, and in particular to the angle proportion projected onto an Y-Z plane, which is also known as a tower angle. If a tilt of the pinion shaft relative to the toothed rack is not set optimally, the tilt may for example lead to undesirable rattling noise or excessive friction and wear. Observing corresponding tolerances however is costly and leads to increased production costs.

U.S. Pat. No. 7,870,805 B2 discloses a steering gear for a motor vehicle, wherein a pinion cooperates with a toothed rack. The toothed rack is held in close contact with the pinion by a spring-loaded guide element. The guide element in turn is guided in a stationary receiver. To prevent the guide element from moving in the receiver and causing rattling noise, it is provided that an effect lines of a force between the guide element and the toothed rack on one side, and of a force between the toothed rack and the pinion on the other, are offset to each other or run at an angle to each other.

U.S. Pat. No. 6,439,337 B1 discloses a rack-and-pinion drive for a motor vehicle steering system in which a toothed rack cooperates with a pinion. The pinion shaft is mounted inside an inner housing that in turn is mounted in a sleeve with eccentric inner surface. The sleeve in turn is mounted via a central outer face so as to be rotatable in a stationary outer housing. By twisting the sleeve therefore, a position of the inner housing can be changed. The pinion shaft is mounted on both sides of the toothed rack via bearings inside the inner housing, so that when the sleeve is twisted, the axis of the pinion shaft is moved transversely to its running direction without changing its angle to the toothed rack.

US 2008/0156573 A1 describes a rack-and-pinion drive in which a toothed rack is preloaded in a direction of a pinion. The preload is exerted via a roller element that rolls on a surface of the toothed rack. To damp vibrations, the roller element has a rubber-elastic element on its peripheral face.

GB 2 014 691 A discloses a rack-and-pinion steering gear in which a steering worm acts on a piston mounted inside a gear housing in order to displace said pinion axially. The piston in turn has a toothed rack profile that cooperates with a toothed segment of a steering shaft. The play between the toothed rack profile and the toothed segment is minimized via an automatic adjustment device. A spring-loaded pressure bolt here exerts a torque on the piston.

U.S. Pat. No. 9,278,870 B2 describes a pressure piece for a rack-and-pinion drive. The pressure piece is in contact with a toothed rack and transmits a spring force in order to preload the toothed rack against a pinion. The pressure piece has a metal cylinder and a contact face made of polymer for the toothed rack.

In view of the described prior art, ensuring optimum engagement between a pinion shaft and a toothed rack leaves room for improvement. In particular, it would be desirable to optimize production costs without this adversely affecting precision.

### SUMMARY

The disclosure is based on an object of providing a rack-and-pinion gear with precise engagement, which can be produced at low cost.

It is pointed out that features and measures listed individually in the description below may be combined with each other in any technically sensible fashion, and indicate further embodiments of the disclosure. The description characterizes and specifies the disclosure further, in particular in connection with the Figures.

The disclosure provides a rack-and-pinion gear for a motor vehicle. In particular, the rack-and-pinion gear may be a steering gear. The motor vehicle may e.g. be a car or a truck. The rack-and-pinion gear has a pinion shaft and a toothed rack that are mounted inside a housing. In the case of a steering gear, it is normally provided that the pinion shaft is connected at least indirectly to a steering wheel. The pinion shaft has a pinion with a circumferential toothing that cooperates with a corresponding unilateral toothing of a toothed rack. A straight toothing or an oblique toothing may be used. Both the pinion shaft and the toothed rack are mounted inside a housing, wherein the pinion shaft is evidently mounted so as to be rotatable, while the toothed rack is mounted so as to be displaceable in a toothed rack running direction. Normally, there is also a slight movability of the toothed rack transversely to the toothed rack running direction. Usually, the pinion is mounted in the housing opposite a spring-loaded pressure piece that serves to press the toothed rod against the pinion.

According to the disclosure, a position of the pinion shaft in the housing can be adjusted by at least one adjustment element so that a tilt of the pinion shaft relative to the toothed rack can be set. In other words, a precise position of the pinion shaft inside the housing and a tilt of the pinion shaft relative to the toothed rack are not precisely predefined in production by a geometry of the housing, but there is a possibility of adjusting this via at least one adjustment element, normally during installation, in particular so as to achieve an optimal engagement between the pinion shaft and the toothed rack. The term “adjustable” means that the tilt can be predefined within a tolerance range that is evidently always present. If the tilt is characterized by a one-dimensional or two-dimensional angular range, the adjustment gives a specific angular range that changes depending on a setting. For example, in one setting the tilt could be between 0° and 1° relative to a suitably selected axis, while in another setting the tilt lies between 3° and 4°.

During installation, an ideal setting can be checked e.g. in that a rolling movement of the toothed rack or an existing play of a pressure piece can be monitored.

Said adjustment facility allows the housing, and in some cases other components, to be produced with larger tolerances, whereby production costs are reduced. Any additional costs caused by the adjustment element may however be comparatively slight, as will be explained below with reference to individual embodiments.

Within certain limits, it is also possible to make an adaptation to other geometries of a steering system without changing the housing. If, e.g. on different versions of a vehicle, a slightly different path (angle) of the pinion shaft is required, this can be achieved via adjustability of the tilt according to the disclosure, without the geometry of the housing needing to be changed.

Preferably, a tilt of the pinion shaft can be set inside a plane parallel to a running direction of the toothed rack. In a steering gear in fitted state, the running direction of the toothed rack corresponds to a Y axis of the vehicle, so that in this embodiment in particular a tilt may be settable within a Y-Z plane. This expressly includes the possibility that, in addition, for example, a setting of the tilt inside a X-Z plane is possible. As will become clear below, in some embodiments a setting of the tilt inside the X-Z plane necessarily entails a setting of the tilt inside the Y-Z plane.

According to one embodiment, the pinion shaft may be mounted inside the housing via an end-side, first bearing and a second bearing opposite the first bearing relative to the toothed rack, wherein the at least one adjustment element is assigned to a bearing. In a steering gear, the pinion shaft normally points obliquely downwards so that the end-side, first bearing could also be described as a lower bearing. The first and second bearings are arranged on opposite sides of the toothed rack or on either side of the pinion. At least one adjustment element is assigned to one of the two bearings. This means that the adjustment element may be part of a corresponding bearing or cooperate therewith. In any case, a result is an adjustability of the corresponding bearing. This in turn leads to the adjustability of the tilt of the pinion shaft. It is pointed out that the pinion shaft as a whole may be mounted via at least one further third bearing that, viewed from the toothed rack, is again arranged on a far side of the second bearing.

Here the at least one adjustment element is preferably assigned to the first i.e. a lower bearing. This may be advantageous because this first, or lower bearing in general is more easily accessible for making the necessary adjustment.

In principle, an adjustability of the first and second bearing is conceivable. It is however sufficient—and, with regard to structural complexity, advantageous—if precisely one bearing can be adjusted by the adjustment element, such that a position of the pinion shaft inside the one bearing can be changed transversely to a pinion shaft running direction. This means that one of the first or second bearings is either configured rigidly, or has a certain play, but in any case without the possibility of adjusting a position of the pinion shaft. The other bearing however is configured adjustably, whereby a position of a part of the pinion shaft arranged inside this other bearing can be changed transversely to the running direction (or in other words, the longitudinal axis) of the pinion shaft. The adjustment process here under certain circumstances could be compared to a pivot movement in which a non-adjustable bearing forms a rotation point and a pivot angle is predefined by adjustment of the other bearing.

According to an advantageous embodiment, which is particularly simple in structural terms, the adjustment element is configured as a bearing bushing for at least indirect mounting of the pinion shaft, wherein the bearing bushing is formed eccentrically and can be arranged in various angular positions around the pinion shaft inside the housing. This embodiment can in general be produced particularly economically. The bearing bushing here receives the pinion shaft, wherein in some cases a further element may be provided e.g. an intermediate roller bearing. The bearing bushing, which may be configured cylindrically for example, has an inner contour for (at least indirectly) receiving the pinion shaft, and an outer contour, which is arranged inside the housing and may e.g. at least partially stand in form-fit engagement therewith. The inner contour is here configured eccentrically relative to the outer contour (or vice versa). Normally, the inner contour has a circular cross-section. The outer contour could have a polygonal, e.g. hexagonal or octagonal, cross-section. A corresponding recess with polygonal cross-section, in which the bearing bushing can be inserted, must be formed on the housing. In the case of a hexagonal cross-section, the bearing bushing could be arranged in six different angular positions about the pinion shaft, wherein because of the eccentric arrangement of the inner contour relative to the outer contour, the inner contour is in each case arranged in a different position relative to the housing. This in turn leads to a different tilt of the pinion shaft relative to the housing and the toothed rack. In this embodiment, a change in tilt inside a plane parallel to a running direction of the toothed rack always also leads to a change in tilt in a plane perpendicular to the running direction of the toothed rack.

Preferably, the bearing bushing can be arranged in any arbitrary angular position. Here, the outer contour, or an outer casing surface of the bearing bushing, has a circular cross-section so that the outer contour can be oriented arbitrarily within a corresponding recess of the housing. In this way, evidently, the tilt of the pinion shaft can be set more variably than with a limited number of possible orientations of the bearing bushing. However, even with a primarily circular outer cross-section, a key flat or outer hexagon or similar could be provided in regions in order to allow a form-fit engagement with a tool, by which the bearing bushing is adjusted.

To prevent the position of the bearing bushing and hence the tilt of the pinion shaft from shifting undesirably during operation, it is preferred if the bearing bushing can be locked in an angular position inside the housing. With a polygonal cross-section, the bearing bushing is in any case arranged so as to be secure against twisting in the housing by a corresponding form-fit engagement. With a circular cross-section however, it may be necessary to provide a locking element or a fixing screw that acts on a side of the bearing bushing. In other cases, a locking element may be omitted e.g. if friction between the bearing bushing and housing prevents twisting.

Normally, as an alternative to the embodiment described above in which an eccentric bearing bushing is arranged in different angular positions, the adjustment element may be assigned to a bearing that is linearly adjustable inside the housing. Here, the adjustment element may again be part of the bearing or may cooperate therewith. The corresponding bearing is normally, continuously, linearly displaceable inside the housing, wherein embodiments could also be considered in which a plurality of discrete, linearly successive positions is possible. A linear displacement of the corresponding bearing also causes displacement of parts of the pinion shaft received in the corresponding bearing, whereby the proposed change of tilt takes place. In general, this embodiment is structurally more complex than that with an eccentric bearing bushing, but it is however possible here to change the tilt in one plane (e.g. in the Y-Z plane) selectively. To prevent undesirable movement of the bearing, for example a locking element may be provided. However, it would also be possible for the bearing to be adjustable via a self-inhibiting drive (e.g. spindle drive).

In principle, various directions for adjustment of the bearing are conceivable. Advantageously, in particular so that a tilt of the pinion shaft can be set optimally inside a plane parallel to the running direction of the toothed rack, the bearing may be adjustable parallel to the running direction of the toothed rack. At the same time, the bearing may be adjustable transversely to the running direction of the pinion shaft.

Further advantageous details and effects of the disclosure are explained in more detail below with reference to various exemplary embodiments shown in the figures. The drawings show:

### BRIEF DESCRIPTION OF THE DRAWINGS

FIG. 1 is a perspective depiction of a steering gear according to the disclosure according to a first embodiment;

FIG. 2 is a sectional depiction of the steering gear from FIG. 1;

FIG. 3 is a sectional depiction along line in FIG. 2;

FIG. 4 is a sectional depiction of a steering gear according to the disclosure according to a second embodiment; and

FIG. 5 is a sectional depiction along line V-V in FIG. 4.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

In the various Figures, the same parts always carry the same reference signs, so that these are usually only described once.

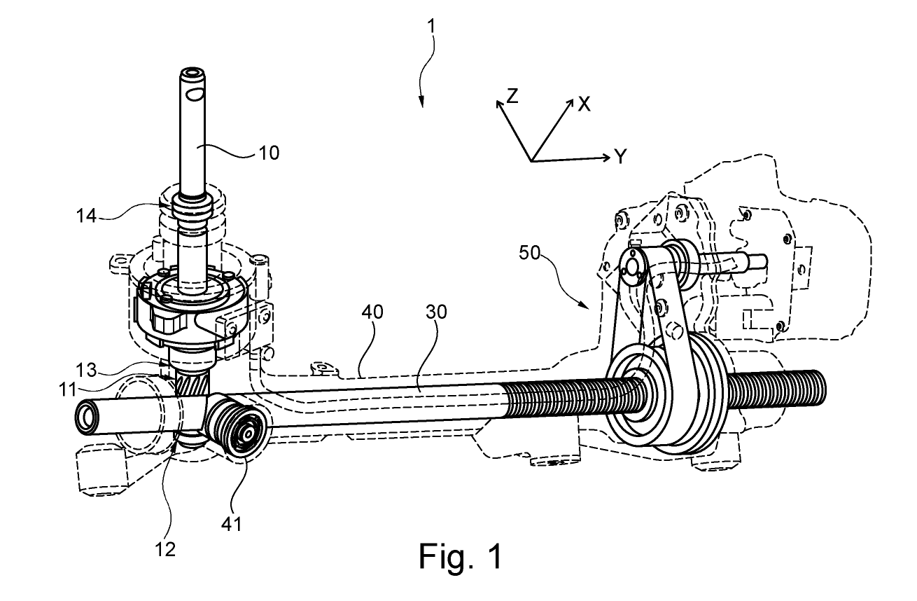

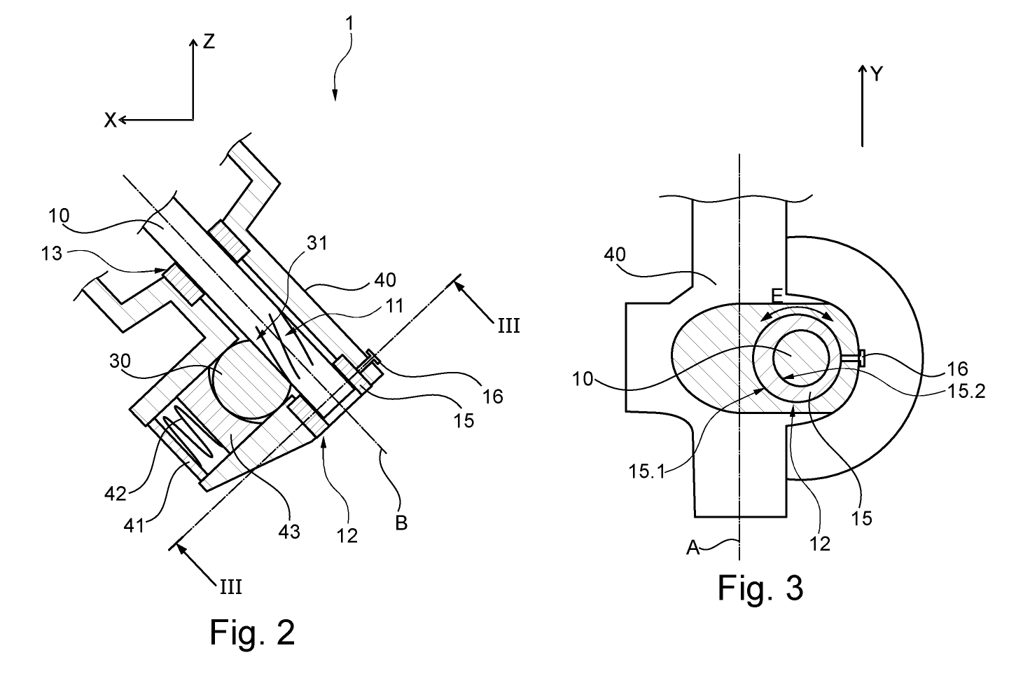

FIGS. 1 to 3 show a first embodiment of a steering gear 1 according to the disclosure, which is configured as a rack-and-pinion gear for a car, wherein FIG. 1 shows a perspective depiction of the entire steering gear 1. This comprises a pinion shaft 10 with a pinion 11 that cooperates with a toothing 31 of a toothed rack 30. In the FIGS. 1 to 3, X, Y and Z axes of a vehicle are drawn according to a proposed installation position of the steering gear 1. A running direction A of the toothed rack 30 is evident parallel to the Y axis, while a running direction B of the pinion shaft 10 runs (at least approximately) inside an X-Z plane. Both the pinion shaft 10 and the toothed rack 30 are mounted inside a housing 40. The toothed rack 30 is displaceable in a direction of the Y axis, and the pinion shaft 10 is rotatable about an axis corresponding to a pinion shaft running direction B.

The rotatable mounting of the pinion shaft 10 is achieved by three bearings 12, 13, 14. A first bearing 12 is arranged on an end side of the pinion shaft 10. A second bearing 13 is arranged opposite the first bearing 12 relative to the pinion 11 or the toothed rack 30. Viewed from the pinion 11, a third bearing 14 is arranged on a far side of the second bearing 13. The precise configuration of the second bearing 13 and third bearing 14 is not relevant in this context; they may for example be roller bearings, which are received stationarily inside the housing 40.

To improve engagement between the toothing 31 and the pinion 11, the toothed rack 30 is loaded by a pressure piece 43 in a direction of the pinion shaft 10. The pressure piece 43 is in turn loaded by a spring 42 that rests on a closing piece 41. Despite this measure, a potential problem could be that the engagement between the pinion shaft 10 and toothed rack 30 is not optimal, which may e.g. lead to undesirable rattling noise. Whether this occurs depends in particular on a tilt of the pinion shaft 10 inside the housing 40 relative to the toothed rack 30. Even minor changes in tilt can decisively influence the engagement.

To avoid a need to produce the housing 40 with particularly tight tolerances, the first bearing 12 is adjustable such that a position of the pinion shaft 10 inside the first bearing 12 can be changed perpendicularly to the running direction B. As evident in particular from FIG. 3, the first bearing 12 has a bearing bushing 15 that serves as an adjustment element and has a circular outer contour 15.1 and, formed eccentrically thereto, an also circular inner contour 15.2. Because of a circular form of the outer contour 15.1, the bearing bushing 15 can be arranged in any arbitrary angular position about the pinion shaft 10. This corresponds to an adjustment movement E indicated by the double arrow in FIG. 3. Depending on setting, the inner contour 15.2 and an end of the pinion shaft 10 received therein move. The adjustment process can be compared to a pivot movement in which the second bearing 13 or the third bearing 14 forms a rotation point and a pivot angle is predefined by adjustment of the first bearing 12. Either the second bearing 13 or the third bearing 14 must have a degree of play in order to allow the adjustment. Due to a change in tilt inside a Y-Z plane, the running direction B of the pinion shaft 10 does not lie precisely in the X-Z plane, depending on setting.

It is evident that a further roller bearing could be arranged between the bearing bushing 15 and the pinion shaft 10, but this has been omitted here for reasons of clarity. Under certain circumstances, friction between the bearing bushing 15 and the housing 40 may be sufficient to prevent undesirable twisting during operation of the vehicle. If this is not the case, the bearing bushing can be locked relative to the housing 40 by a locking screw 16 after an optimal angular position has been found. To facilitate adjustment of an angular position, the bearing bushing 15 may have end-side structures for form-fit engagement with a tool, e.g. a hexagonal recess or similar.

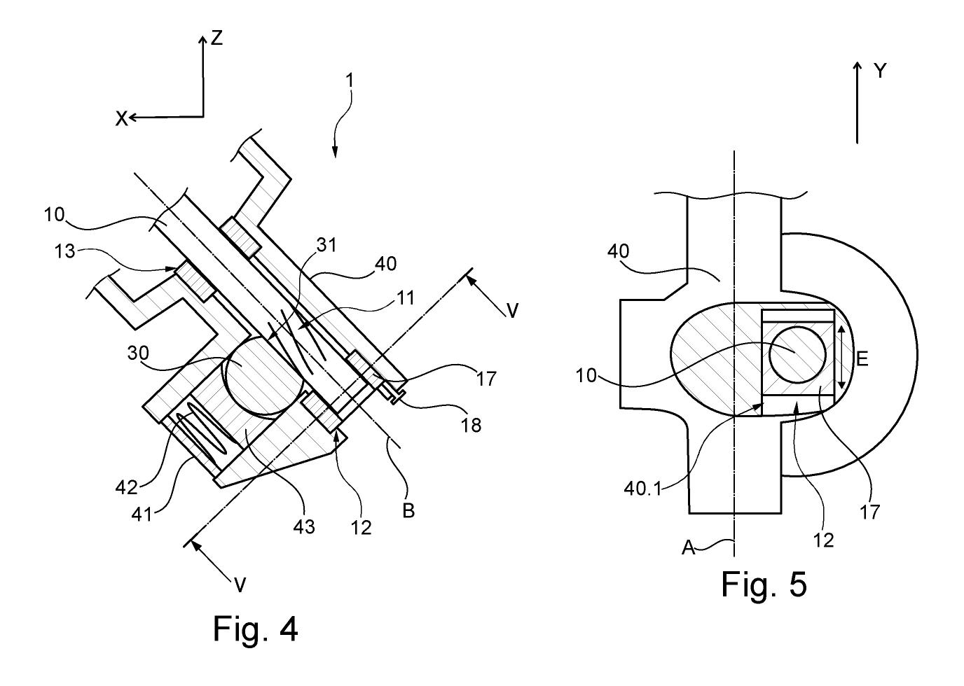

FIGS. 4 and 5 show a second embodiment of a steering gear 1 according to the disclosure, which substantially corresponds to the embodiment shown in FIGS. 1 to 3 and to this extent is not explained again. Instead of the eccentric bearing bushing 15, the first bearing 12 has a bearing piece 17, inside of which one end of the pinion shaft 11 is received. Here again, a roller bearing (not shown) could be provided between the bearing piece 17 and the pinion shaft 11. The bearing piece 17 is linearly adjustable inside a guide channel 40.1 of the housing 40, wherein the double arrow in FIG. 5 again indicates adjustment movement E, which is parallel to the running direction A of the toothed rack 30 and to the Y axis. In this embodiment, friction forces between the bearing piece 17 and the housing 40 are not normally sufficient to prevent undesirable displacement during operation of the vehicle. For this reason, in general, a locking screw 18 shown in FIG. 4 must be provided that locks the bearing piece 17 after an optimal tilt of the pinion shaft 11 has been set.

Whereas in the first exemplary embodiment, an adjustment of the tilt of the pinion shaft inside the Y-Z plane parallel to the running direction A of the toothed rack always entails an adjustment within the X-Z plane, in the second exemplary embodiment a selective change of tilt inside the Y-Z plane is possible without changing the tilt inside the X-Z plane.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A rack-and-pinion gear for a motor vehicle, comprising:
a pinion shaft; and
a toothed rack mounted inside a housing, wherein a position of the pinion shaft in the housing is adjusted by at least one adjustment element so that a tilt of the pinion shaft relative to the toothed rack is set.

2. The rack-and-pinion gear as claimed in claim 1, wherein the tilt of the pinion shaft is set inside a plane parallel to a running direction of the toothed rack.

3. The rack-and-pinion gear as claimed in claim 1, wherein the pinion shaft is mounted inside the housing via an end-side first bearing and a second bearing opposite the first bearing relative to the toothed rack, wherein the at least one adjustment element is assigned to the first or second bearing.

4. The rack-and-pinion gear as claimed in claim 3, wherein the at least one adjustment element is assigned to the first bearing.

5. The rack-and-pinion gear as claimed in claim 3, wherein precisely one of the first or second bearings is adjusted by the adjustment element such that a position of the pinion shaft inside the one of the first or second bearings is changed transversely to a running direction of the first or second bearing.

6. The rack-and-pinion gear as claimed in claim 1, wherein the adjustment element is a bearing bushing that indirectly mounts the pinion shaft, wherein the bearing bushing is formed eccentrically and has various angular positions around the shaft inside the housing.

7. The rack-and-pinion gear as claimed in claim 6, wherein the angular positions of the bearing bushing are arbitrary.

8. The rack-and-pinion gear as claimed in claim 6, wherein the bearing bushing is locked in an angular position inside the housing.

9. The rack-and-pinion gear as claimed in claim 1, wherein the adjustment element is assigned to a bearing that is linearly adjustable inside the housing.

10. The rack-and-pinion gear as claimed in claim 9, wherein the bearing is adjustable parallel to a running direction of the toothed rack.

11. A vehicle comprising:
a steering gear including a pinion shaft with a pinion that cooperates with a tooth of a toothed rack mounted inside a housing; and
a bearing bushing formed eccentrically with various angular positions around the pinion shaft inside the housing that adjusts a position of the pinion shaft in the housing such that a tilt of the pinion shaft relative to the toothed rack is adjustable inside the housing.

12. The vehicle as claimed in claim 11, wherein the tilt of the pinion shaft is set inside a plane parallel to a running direction of the toothed rack.

13. The vehicle as claimed in claim 11, wherein the pinion shaft is mounted inside the housing via an end-side first bearing and a second bearing opposite the first bearing relative to the toothed rack, wherein the bearing bushing is assigned to the first or second bearing.

14. The vehicle as claimed in claim 13, wherein precisely one of the first or second bearings is adjusted by the bearing bushing such that a position of the pinion shaft inside the one of the first or second bearings is changed transversely to a running direction of the first or second bearing.

15. The vehicle as claimed in claim 11, wherein the bearing bushing is assigned to a bearing that is linearly adjustable inside the housing.

16. A steering system comprising:
a steering gear including a pinion shaft with a pinion that cooperates with a tooth of a toothed rack mounted inside a housing; and
a bearing bushing that adjusts a position of the pinion shaft in the housing such that a tilt of the pinion shaft relative to the toothed rack is locked at an angular position inside the housing.

17. The steering system as claimed in claim 16, wherein the tilt of the pinion shaft is set inside a plane parallel to a running direction of the toothed rack.

18. The steering system as claimed in claim 16, wherein the pinion shaft is mounted inside the housing via an end-side first bearing and a second bearing opposite the first bearing relative to the toothed rack, wherein the bearing bushing is assigned to the first or second bearing.

19. The steering system as claimed in claim 18, wherein precisely one of the first or second bearings is adjusted by the bearing bushing such that a position of the pinion shaft inside the one of the first or second bearings is changed transversely to a running direction of the first or second bearing.

20. The steering system as claimed in claim 16, wherein the bearing bushing is assigned to a bearing that is linearly adjustable inside the housing.
